(19) United States
(12) Patent Application Publication
(10) Pub. No.: US 2026/0188793 A1
(43) Pub. Date: Jul. 2, 2026

(54) CONFORMING POUCH FOR SOLID-STATE BATTERY CELLS

(71) Applicant: Solid Power Operating, Inc., Louisville, CO (US)

(72) Inventors: Harris Akhtar IQBAL, Denver, CO (US); Dylan Gilgallon, Boulder, CO (US); Ramanan Ganeshananthan, Louisville, CO (US)

(21) Appl. No.: 19/435,312

(22) Filed: Dec. 29, 2025

Related U.S. Application Data
(60) Provisional application No. 63/740,682, filed on Dec. 31, 2024.

(51) Int. Cl. H01M 50/105; H01M 10/0562; H01M 10/0585; H01M 50/178; H01M 50/533; H01M 50/54

(52) U.S. Cl. CPC H01M 50/105; H01M 10/0562; H01M 10/0585; H01M 50/178; H01M 50/533; H01M 50/54

(57) ABSTRACT

A battery cell is provided that includes a countered pouch form, tailored to match the geometry of the cell, including the tab region. The contoured pouch form provides a precise, conforming seat for the cell and tab region to reduce or mitigate deformation of cracking of layers of the pouched cell, particularly during vacuum sealing of the pouch. By optimizing the pouch form geometry to the shape of the contained stack, the structural integrity and reliability of battery pouch cells is improved.

### CROSS-REFERENCE TO RELATED APPLICATION

This application is related to and claims priority under 35 U.S.C. § 119(e) from U.S. Patent Application No. 63/740,682 filed Dec. 31, 2024 titled “Conforming Pouch for Solid-State Battery Cells,” the entire contents of which is incorporated herein by reference for all purposes.

### TECHNICAL FIELD

This disclosure relates to the field of electrochemical batteries and, in particular, this disclosure relates to a pouch design for a pouched battery cell design to mitigate defects in an all-solid-state battery cell.

### BACKGROUND AND INTRODUCTION

The proliferation of battery powered devices including for use in electric and hybrid automobiles among others, is motivating innovations in all aspects of battery technologies. Solid-state battery technologies represent opportunities to improve on a host of areas that are important for commercial application of batteries including reliability, capacity (mAh), thermal characteristics, safety, cycle life, and recharge performance, among others.

A solid-state battery includes a solid electrolyte between an anode and a cathode, forming an electrochemical cell. One key difference between a conventional liquid electrolyte battery and a solid-state battery is the use of a solid electrolyte. In a solid-state cell, the solid electrolyte serves the purpose of a separator and hence the solid electrolyte is often referred to as a separator. The electrochemical battery cell is often disposed within a pouch, bag, or similar structure to hermetically seal and protect the electrochemical cell and internal cell components. The anode and cathode may extend from the pouch or be electrically coupled to respective tabs or terminals that extend from the pouch to facilitate electrical connection to the electrochemical cell. A given battery may include one or more discrete cells with batteries having more and/or larger cells generally providing greater storage capacity than batteries having fewer/smaller cells.

In a lithium-based battery cell, which may serve as an example of the operation of other various types of cells, the anode (negative electrode) and cathode (positive electrode) store the lithium with positively charged lithium ions moving back and forth between the anode and the cathode through the electrolyte. During discharge, ions are released from the anode and flow, through the electrolyte, to the cathode whereas electrons flow from the anode to a load and back to the cathode. In a liquid electrolyte cell, a separator blocks the flow of electrons inside the battery directly from the anode to the cathode, which prevents self-discharge. In the case of solid-state cells, as noted above, the solid-state electrolyte serves the purpose of a separator.

While solid-state batteries may be considered safer than liquid electrolyte-based batteries due to an inherently lower risk of overheating and shorting, the substantial amount of energy potentially stored in a solid-state battery still motivates safety to be a top priority for manufacturers and users. For example, small physical/mechanical informalities in the layers of a solid-state battery may cause a short condition between two or more electrodes. Engineers often need to account for possible damage to the battery during the manufacturing process and work to mitigate such inconsistencies within the battery design to prevent potentially dangerous battery failures.

Some or all of these and other issues are addressed by various aspects of the present disclosure discussed in detail below.

### SUMMARY

Aspects of the present disclosure involve a battery cell comprising a cell stack comprising a plurality of current collectors in an extended portion of the cell stack and a pouch. The pouch includes a recess formed around the cell stack and a conforming portion extending from the recess, the conforming portion receiving the extended portion of the cell stack adjacent to a conductive tab electrically coupled to the plurality of current collectors in the extended portion of the cell stack.

Another aspect of the present disclosure involves a method for a battery cell. The method may include the operations of locating a cell stack of a battery in a first recess of a first pouch side, the cell stack comprising a plurality of current collectors in an extended portion of the cell stack, wherein the first pouch side comprises a first conforming portion adjacent to the first recess, the first conforming portion receiving a bottom of the extended portion of the cell stack adjacent to a conductive tab electrically coupled to the plurality of current collectors in the extended portion of the cell stack. The method may also include locating a second pouch side over the cell stack opposite the first pouch side, the second pouch side comprising a second conforming portion adjacent to the second recess, the second conforming portion receiving a top of the extended portion of the cell stack and sealing the first pouch side to the second pouch side to encase the cell stack.

Yet another aspect of the present disclosure involves a conforming pouch for a battery cell. The conforming pouch may include a first portion to receive a body of the battery cell and a second portion extending laterally from the first portion. The second portion may receive a conductive tab extending laterally from the body of the battery cell and comprise a rigid first concave portion disposed over the conductive tab to protect the conductive tab during sealing of the battery cell within the conforming pouch.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIGS. 1A and 1B are representative side views of example battery cells according to aspects of the present disclosure.

FIG. 2A is a representative side section view of a battery cell according to another embodiment of the present disclosure.

FIG. 2B is a representative top view of a battery cell according to another embodiment of the present disclosure.

FIG. 3A is a representative side section view of an example tab structure of a battery cell according to aspects of the present disclosure.

FIG. 3B is a representative angled view of an example tab structure of a battery cell according to aspects of the present disclosure.

FIG. 4 is a representative angled view of a conforming pouch for a battery cell according to aspects of the present disclosure.

FIG. 5 is a representative angled side section view of a recessed portion of a conforming pouch for a battery cell according to aspects of the present disclosure.

FIGS. 6A and 6B are representative side section views of a recessed portion of a conforming pouch for a battery cell according to aspects of the present disclosure.

FIG. 7A is a top view of a traditional pouch for a battery cell and FIG. 7B is a top view of a contoured pouch for a battery cell according to aspects of the present disclosure.

FIG. 8 is a representative flowchart of a method for utilizing a contoured cell pouch to seal a battery cell within a pouch according to aspects of the present disclosure.

### DETAILED DESCRIPTION

Aspects of this disclosure are directed to a contoured pouch form for all-solid-state battery (ASSB) cells, tailored to match the geometry of the cell, including the tab region. The contoured pouch form provides a precise, conforming seat for the cell and tab region to reduce or mitigate deformation or cracking of layers of the pouched cell, particularly during vacuum sealing of the pouch around the cell stack. By optimizing the pouch form geometry to the shape of the contained cell, the structural integrity and reliability of ASSB pouch cells is improved. While various aspects of the present disclosure are discussed with reference to solid-state batteries with opposing connection tabs, it should be recognized that concepts may apply to other solid-state battery forms such as, but not limited to, those with tabs extending from the same side of the pouch.

The term “battery” in the art and herein can be used in various ways and may refer to an individual cell having an anode and cathode separated by an electrolyte, which may be a solid electrolyte, as well as a collection of such cells connected in various arrangements. A solid-state electrolyte cell may include more than one anode and cathode, separated by solid electrolyte layers, and may be encased within a flexible “pouch” that accommodates the expansion and contraction of the anode(s) and cathode(s) as the cell charges and discharges. Although many examples are discussed herein as applicable to a battery or a discrete cell, it should be appreciated that the systems and methods described may apply to many different types of batteries, battery chemistries, and may range from an individual cell to batteries involving different possible interconnections of cells such as cells coupled in parallel, series, and parallel and series. The electrodes (e.g., the cathodes and anodes) are in conductive communication with terminals or tabs that extend outside the pouch to enable electrical coupling of the battery to a battery terminal and/or to a circuit connecting multiple battery cells.

Conventional pouch structures rely on a tri-layer Polypropylene-Aluminum-Nylon (or “P-A-N”) construction. For example, certain conventional pouch cells are formed by positioning two P-A-N stacks on opposite sides of the cell with the polypropylene layers as the innermost layer of the stack, the nylon layer outwardly facing and the aluminum foil layer between them. Pressure and heat are subsequently applied to this sandwiched configuration, before and after the interior of the pouch with the cell is vacuumed to remove air, to fuse the polypropylene layers together around the internal cell components, thereby sealing the internal cell components in a vacuum-sealed pouch.

The above-described process of sealing a stack of electrodes (otherwise referred to herein as a “cell” or a “cell stack”) within a pouch may cause damage to one or more of the sensitive layers of the cell, however. For example, traditional rectangular pouch forms create mechanical interferences in the tab area, causing non-uniform stresses during the vacuum sealing process. These stresses may force the electrode layers into the pouch sidewalls, leading to cracking and mechanical damage, particularly in the anode and separator layers.

To address these concerns, a pouch form design may be utilized that closely matches or approximates the geometry of the cell, including the tab region. In general, a pouch with at least one contoured, conforming seat for the cell reduces the mechanical interferences that damage the layers of the encompassed battery cell which may be caused by traditional rectangular pouch forms. In particular, during the vacuum sealing process, the tailored pouch shape ensures even stress distribution across the cell, significantly reducing the risk of cracking or mechanical damage to the anode and separator layers (among other aspects of the layers of the battery cell stack).

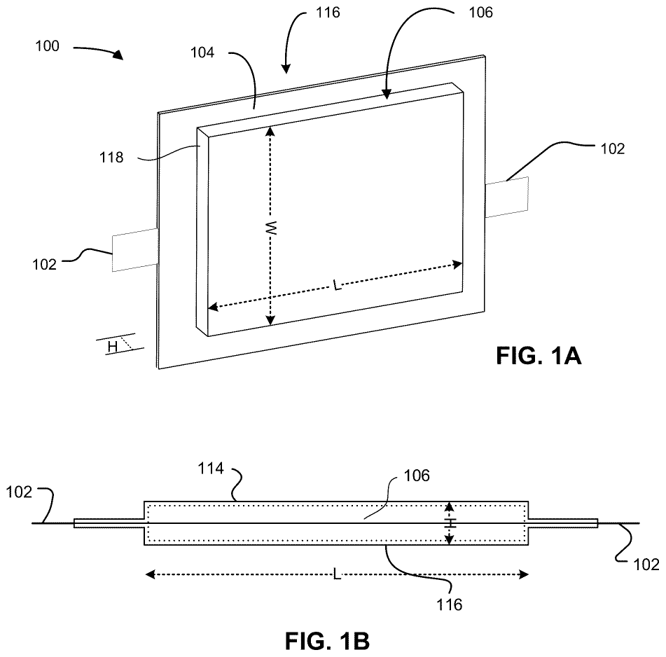

To begin, FIG. 1A illustrates an isometric view of one possible example of a conventional pouch cell 100. In this example, the pouch cell 100 is generally rectangular in shape with conductive tabs 102 extending from opposing ends of the pouch cell. The conductive tab 102A extending from one end of the pouch cell is connected with the anode of the electrochemical cell inside, typically at a current collector, and the conductive tab 102B at the other end of the pouch cell is connected with the cathode of the electrochemical cell 106, also at a current collector. Pouch cells may be of varying configurations including different shapes, such as the shape of a rectangle or square in possible examples. In the example illustrated in FIGS. 1A and 1B, the pouch cell 100 includes a sealed rectangular periphery 104 around the enclosed battery cell 106. The sealed periphery 104 is located where the outer flexible pouch material layers extend beyond the encapsulated area of the layered cell structure, such as electrochemical cell 106, within the bonded and sealed layered structure of the pouch.

FIGS. 1A and 1B illustrate a pouch cell 100 including an overall length and width with a portion 118 encapsulating a cell structure 106 having a length (L) and a width (W) each less than the overall length and width of the pouch cell due to the periphery 104, as well as the tabs if considered part of the length. The portion 118 also includes a height (H). In this example, the conductive tabs 102 are located at opposing ends of the pouch cell and are located in a plane that corresponds to about the middle of the height (H) dimension of the pouch cell. It should be noted that conductive tabs 102A, 102B could be located at any suitable height (H) dimension in various possible embodiments of the present disclosure. The tabs may also extend from the same side or may extend from pouch cell in other ways to conform to whatever end use for the pouch cell.

The cell 100 has a first surface 114 and a second surface 116 between which the cell structure 106 is located. As mentioned above, certain conventional pouch cells are formed by positioning two pouch sides on opposite sides of the cell 106. Pressure and heat are subsequently applied to this sandwiched configuration with the cell 106 between or inside the two pouch sides to fuse the polypropylene layers together around the internal cell components. For example, the cell structure 106 may be placed in a fitted recess of a bottom or lower pouch side (the outer surface of which forms the second surface 116). An upper or top pouch side may similarly include a fitted recess to accommodate the upper portion of the cell 106 such that, when the upper pouch side is placed over the cell, an enclosure for the cell is created. Pressure and heat are then applied to portions of the periphery 104 to seal the cell 106 within the pouch. As noted above, the process of encasing the cell 106 within the pouch may include vacuuming the interior of the pouch to remove air and moisture from the pouch before a final seal is generated around the cell.

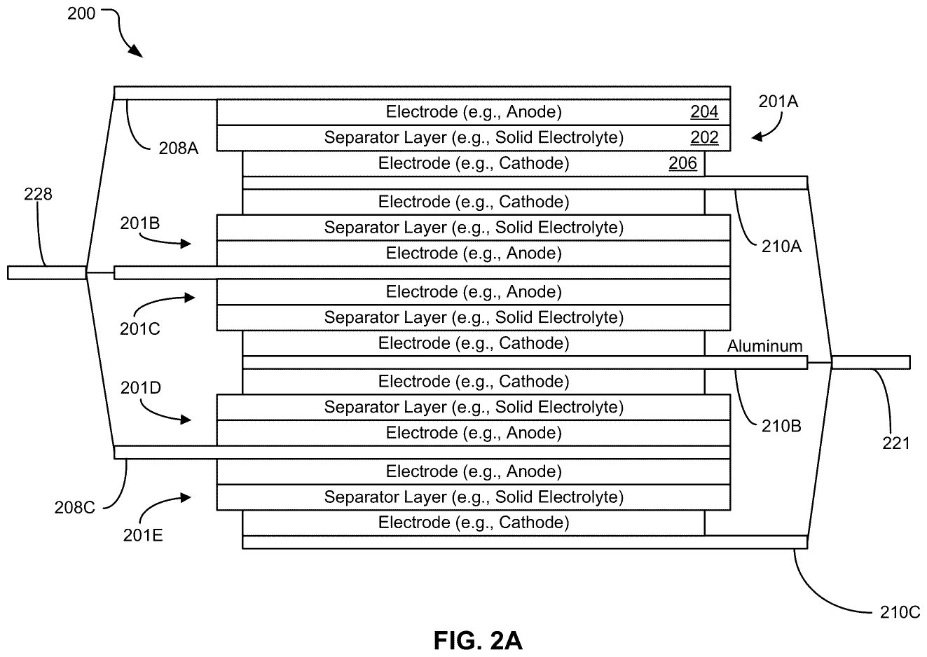

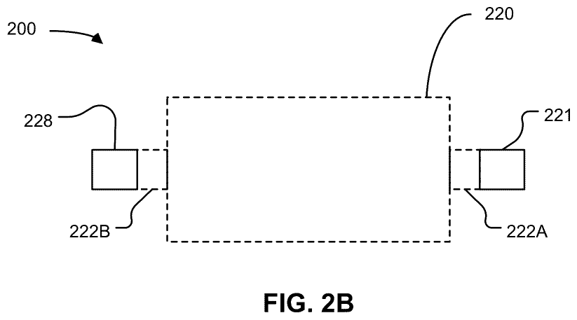

FIG. 2 is an example of a battery cell 200 including a plurality of discrete cell units 201 forming the cell 106 within the pouch. In this example, each cell unit 201A-201E includes a separator layer 202 that is a solid electrolyte positioned between two electrodes—the anode (−) 204 and the cathode (+) 206. In the illustrated example, the anode 204, solid-electrolyte 202, cathode 206 stack is shown in a representative side section view, and each layer of the stack comprises a relatively planar structure, typically a rectangle. In the case of a pouch battery 200, the cell stack is encapsulated in a flexible pouch as discussed. The anode 204 is conductively coupled with an anode current collector 208 and the cathode is conductively coupled with a cathode current collector 210. In various possible examples, the current collectors are formed from a conductive foil or sheet and are in contact with the respective electrodes. In various examples and in combination with different material electrodes, the current collectors may be formed of aluminum or copper foils. The current collectors 208, 210 are coupled with a respective positive tab 228 or negative tab 221 or other conductive structures by which the battery cell is connected to a load and/or other battery cells. It can be seen that the battery 200 includes repeating cell structures in an alternating arrangement so that anodes or cathodes of adjacent cell units are each in conductive contact with the appropriate current collector.

In a battery cell with a plurality of cell units, each of the anodes (−) and each of the cathodes (+) are conductively coupled with a respective negative tab 221 or positive tab 228, representing the opposing polarities of the battery. In some arrangements, like shown in FIG. 2, cell units 201 are layered in an alternating pattern so that anodes or cathodes are facing each other, and may thus share a common current collector, which in turn are coupled with the appropriate tabs. Further, although a few cell units are illustrated, the cell 200 may include many such alternative cell units, each connected to the respective positive or negative tab.

As seen in the top view of FIG. 2B, the stack of layers 220 of the battery cell 200 may be rectangular in shape, with two extended portions 222 on opposing ends to couple with the tabs 221, 228. In general, any of the layers of the cell may extend into the extended portions 222; however, it is the respective cathode and anode current collector layers 208, 210 that are electrically coupled with the tabs 228 and 221. In most instances, the width of the extended portions 222 may be less than the overall width of the cell stack 220 and may or may not be the same width as the corresponding tabs 221, 228. Further, the layers of the cell 220 may have varying dimensions that may or may not include an extended portion. For example and as shown in FIG. 2A, the cathode layer 206 may have a smaller width and/or length as the anode layer 204. In addition, although not illustrated, the separator layer 202 may have a longer width and/or length than either of the anode layer 204 and the cathode layer 206 to ensure that electrical isolation is maintained at all times between the opposite polarity electrode layers. Thus, at least a portion of each of the separator layers 202 may extend into the extended portion area 222.

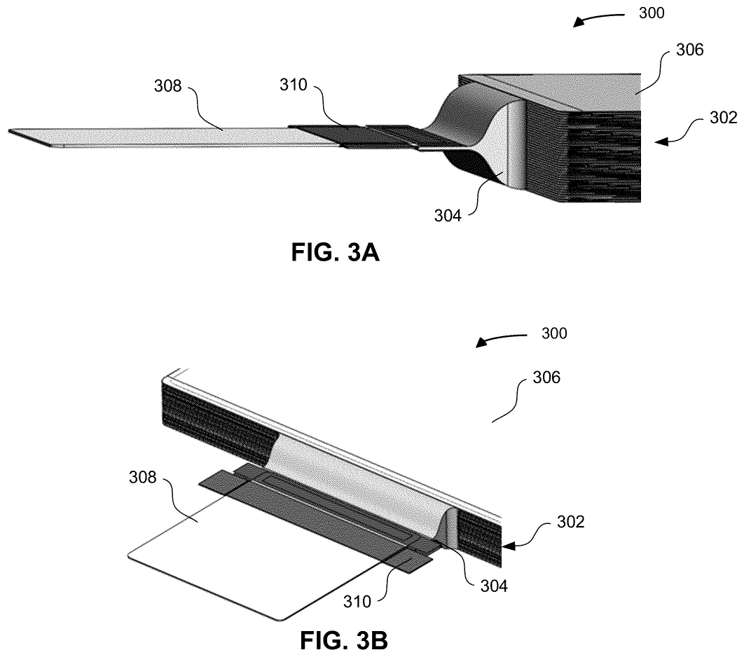

FIGS. 3A and 3B are representative partial isometric views of an example tab structure of a battery cell according to aspects of the present disclosure. As described above, the battery cell 300 may include a series of cell units 302 comprising layers of anode, cathode, separator, current collectors, etc. As also described above, the current collectors 208, which are coupled to the anode layers 204, may be further conductively coupled with a positive tab 228 and the current collectors 210, which are coupled to the cathode layers 206, may be further conductively coupled to a negative tab 221 for connection to a load and/or other battery cells. Portions of the current collector layers may extend into the extended portions 222 of the cell 206 for the coupling to the respective tabs. For example, as shown in FIGS. 3A and 3B, the group of current collectors 304 of the stack of layers 302 of the cell may be physically brought together or pinched at the extended portions 222 and coupled to the corresponding conductor tab 308. In one implementation, the extended portions 222 of the cell may be soldered or welded to the corresponding conductor tab 308. As should be appreciated, some of the current collector layers may be bent up or down to be brought together with the other current collector layers at the tab 308, forming the pinched collection of layers 304 of the extended portions 222. In particular, current collector layers near the upper and lower sides of the cell 300 may have more a bend than layers near the middle of the stack 302. Similarly, portions of the other layers of the cell stack that extend into the extended portions 222 of the cell 302 may also be bent as the current collector layers are bent to connect to the corresponding tab. For example, portions of the anode layer 204 and/or the separator layer 202 may also be included in the extended portions 222 and may for part of the pinched layers 304. In some instances, the tab 308 may also include a sealing strip 310 around which the pouch may be sealed, as explained in more detail below. The sealing strip 310 may also electrically isolate the tab 308 from the pouch.

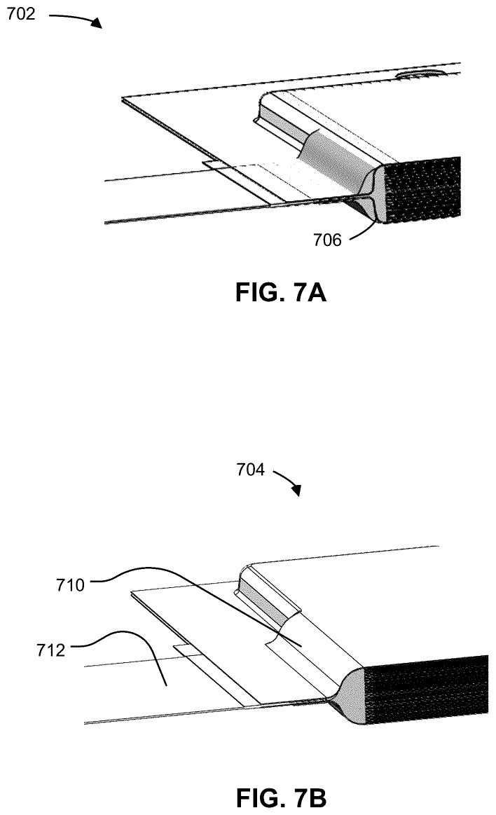

This bending of one or more layers of the cell stack 302 may become more severe during the sealing of the cell stack 302 within the pouch through the conventional process described above using a conventional pouch that does not include tab conforming sections. In particular, the placement and vacuum sealing of the cell stack 302 in a generally rectangular recess of the top and bottom pouches may cause greater bending and strain, particularly at the layers near the top and bottom, of the layers of the extended portion 222 of the cell stack 220 when using a conventional pouch and vacuum sealing along a straight line at the edges of the tabs instead of having a conforming section. For example, FIG. 7A is a top view 702 of a traditional cell pouch after sealing and illustrates the straight bend 706 along the edge of the cell stack near the tabs. This severe bending of the layers, particularly the portions of the separator layers 202 that extend into the extended portions 222 of the cell stack 220, may cause damage to the layers, such as a cracking or other deformities within the layers. Traditional pouch forms with simple rectangular recesses don't account for the extended portion of cell stack such that, during the vacuum process, the pouch may tightly conform around the stack 220 and cause additional and sometimes damages stresses on one or more of the layers of the stack. These stresses may lead to cracks in the layers or other mechanical damage that may impact the performance or safety of the battery cell.

To address these concerns, a conforming pouch form design may be used that closely matches the geometry of the cell 220, including the extended portions 222. By providing a contoured, conforming seat for the electrode layers, the pouch form reduces the mechanical interferences and strain caused by traditional rectangular pouch forms to prevent damage to one or more of the stack layers. During the vacuum sealing process, the tailored pouch shape ensures distribution of stress across the cell, significantly reducing the risk of cracking or mechanical damage to the anode and separator layers. The conforming pouch form mitigates the over-constraining forces that arise when the cell is placed in a generic rectangular pouch and, by accommodating the electrode tab geometry, it prevents layers from being forced into the sidewalls during vacuum sealing, a key contributor to defects in traditional designs. This targeted stress reduction improves the manufacturing yield and the mechanical reliability of the pouch cell.

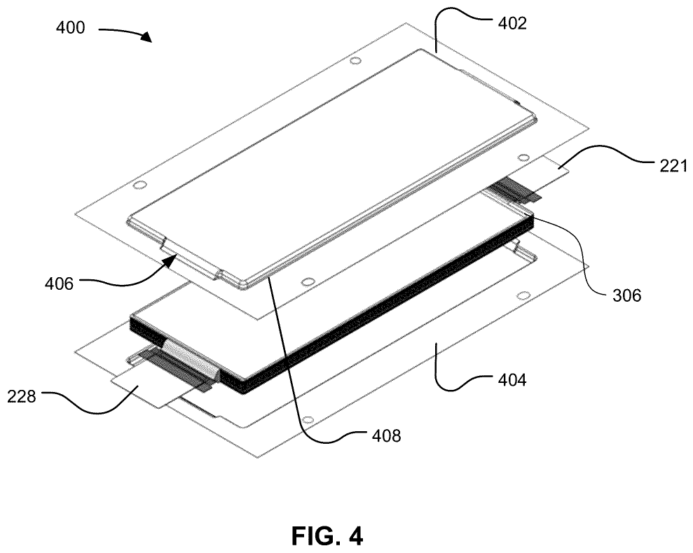

FIG. 4 is a representative angled view of a conforming pouch 400 for a battery cell 306 according to aspects of the present disclosure. The conforming pouch may include a tab conforming section that extends from the side of the pouch where the tabs and current collectors connect. From the perspective of the respective layers, including the current collector layers, that are bent and come together to connect to the tabs in the same location and are provided strain relief by the conforming design, the conforming sections may be considered shaped tab conforming section 406 to accommodate aspects of the cell 306 to reduce stresses on the cell stack layers during sealing. For purposes of discussion, the tab conforming sections will be referred to as shaped recesses herein. In one particular implementation, the shaped tab conforming section 406 may accommodate the layers of the extended portion 222 of the cell stack 306 to prevent significant bending of the layers that may lead to cracking or other mechanical damage of the layers.

In general, the contoured pouch 400 operates in the same or similar manner as the traditional rectangular pouch. For example, the contoured pouch 400 may include an upper or top pouch side 402 and a lower or bottom pouch side 404. Each of the top pouch side 402 and the bottom pouch side 404 may include a recess to receive the cell stack 306. As above, the top pouch side 402 and the bottom pouch side 404 may be vacuumed sealed to vacuum seal the cell stack 306 within the pouch.

The contoured pouch 400 of FIG. 4 may include one or more shaped or contoured tab conforming sections 406. In the example shown in FIG. 4, contoured tab conforming section 406 may correspond to the extended portions 222 of the cell stack 220 to reduce the stress at that location during the sealing process. In some instances, a similar contoured tab conforming section 406 may be located in the top pouch side 402 and the bottom pouch side 404 to accommodate the layers above and below the tab of the extended portion 222 of the cell stack 220. The contoured tab conforming section 406 may also include a shaped sidewall 408 to reduce the stress of the sealing process on the layers of the cell stack 220 other than near the tabs 228, 221. In general, both or either of the pouch sides 402, 404 may include a contoured tab conforming section that includes a shaped section and/or contoured wall 406 to accommodate the cell stack 220 and reduce stress on the layers of the stack during the sealing process.

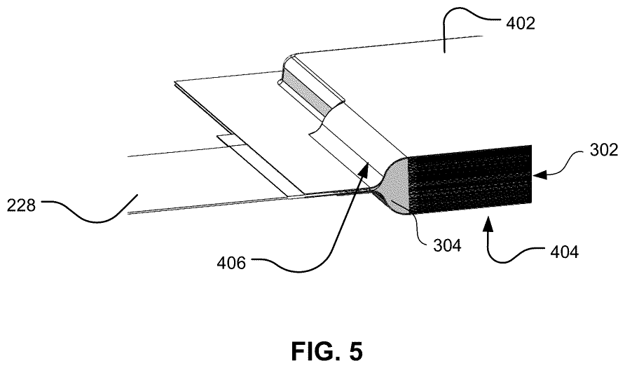

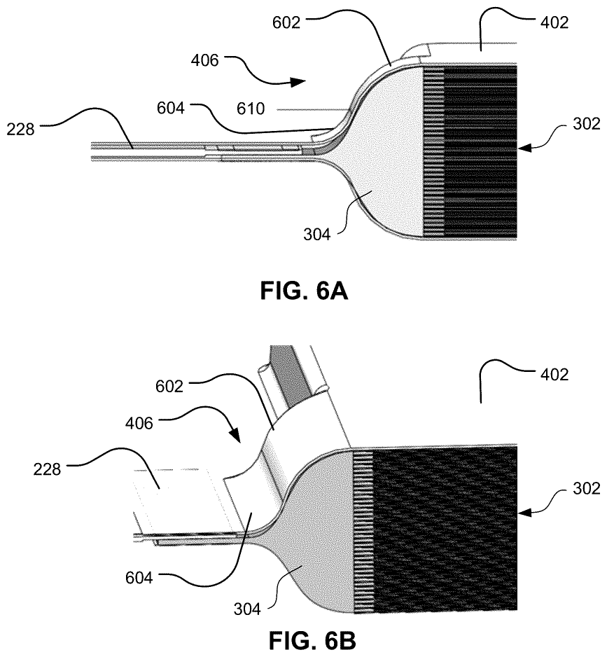

As shown in FIG. 5, the contoured tab conforming section 406 of the top pouch side 402 and/or bottom pouch side 404 may include a generally arcuate shape to accommodate the extended portion 222 of the cell stack 302. In one particular example illustrated in FIGS. 5 through 6B, the contoured tab conforming section 406 may comprise a first curved portion with a convex shape 602 and a second curved portion with a concave shape 604 relative to the tab 228 connection. The contoured tab conforming section 406 may include a center point 610 at which the contoured tab conforming section 406 transitions from the convex shape 602 to the concave shape 604. The structure of the contoured tab conforming section 406 may accommodate connection of the current collector layers to the tab 228 in such a manner that reduces the stress on the layers of the cell stack 302 and prevents or lessens mechanical damage or strain on the layers. In particular, the contoured tab conforming section 406 reduces the near straight-line bend on the layers of the cell stack 302 that may occur during the sealing process when pouch sides with traditional rectangular recesses (from the perspective the entire cell) are used. Rather, the contoured tab conforming section 406 structure prevents the vacuum sealing from straining the fragile pinched layers 304 at the conductive tabs. By providing a gradual bend to the layers of the cell stack 302 through the contoured tab conforming section 406 portion of the pouch, the layers are less likely to crack or break during the sealing process to reduce the mechanical inconsistencies that may occur.

The contoured tab conforming section 406 may be included in both the top pouch side 402 and the bottom pouch side 404 to reduce the sealing damage on the layers of the pinched portion 304 of the cell stack 302. The sealing process may occur similar to that described above with the contoured pouch sides. For example, the cell structure 302 may be placed in the contoured recess of a bottom or lower pouch side 404 with the pinched portion 304 of the cell adjacent to the contoured portion 405 of the pouch side. An upper or top contoured pouch side 402 may similarly include a fitted recess to accommodate the upper portion of the cell 302 such that, when the upper pouch side is placed over the cell, an enclosure for the cell is created. The pinched portion 304 of the cell 302 may be adjacent the contoured portion 406 of the upper pouch side 402, as well. When the pressure, heat, and vacuuming process is applied to of the periphery of the pouch sides 402, 404 to seal the cell 302 within the pouch, the contoured portion 406 of the recesses may reduce the pressure applied to the layers of the pinched area 304. For example, FIG. 7B is a top view 704 of a contoured pouch illustrating the contoured section 710 across the conductive tab 712 of the pouched cell. In comparison with the traditional pouch design illustrated in FIG. 7A, the contoured section reduces the strain occurring on the layers of the cell at the tab. The pouch may also, as described above, seal to the tab 228 or a sealing strip 310 across the tab. In some instances, the sealing strip 310 may be located further from the cell stack 302 than in a traditional pouch to accommodate the recessed contour 406 while still providing for a surface for the pouch to seal around the tab 228.

Returning to FIG. 4, the contoured tab conforming section 406 portion of the pouch sides 402, 406 may have the same or less width as the rectangular tab conforming section 408. In some instances, the width of the contoured tab conforming section 406 may be at least greater than the width of the extended portion 222 of the cell stack 220 to accommodate the layers of the extended portion. In other instances, the width of the contoured tab conforming section 406 may be greater than the width of the corresponding conductive tab 228 adjacent to the section.

In still other implementations, a portion of the entirety of the border of the sidewall 408 of the recess of the pouch side 402 may include some contoured shape to reduce the stress on the layers of the stack 306 during sealing. For example, the sidewall 408 may include a rounded corner along the bottom edge of the recess. The sidewall 408 may also be tapered along the height of the wall to further reduce any bending stress applied to the cell stack layers during sealing. In general, any portion of the recess of the recess of the pouch side 402 may be contoured to be less than a vertical or near vertical wall such that the sidewalls of the pouch recess do not damage the cell stack layers during sealing.

The contoured pouch sides described herein may be utilized for any pouch design to accommodate a tab area of the cell stack regardless of the location of the tab area. For example, some pouch cells include a flat-bottom in which the tabs extend from a bottom surface of the cell stack. In this configuration, the top pouch side may include a contoured recess as discussed above to accommodate the cell layers above the tab. In another implementation, the tabs may each extend from the same side of the cell stack. Such a battery configuration may include one or more pouch sides with contoured features or areas corresponding to the location of the tabs and/or extended portions of the cell stack. In general, a contoured recess may be included in a pouch side to correspond to the location of tab or extended portion of a cell stack to reduce the stresses on the layers of the stack during sealing of the pouch.

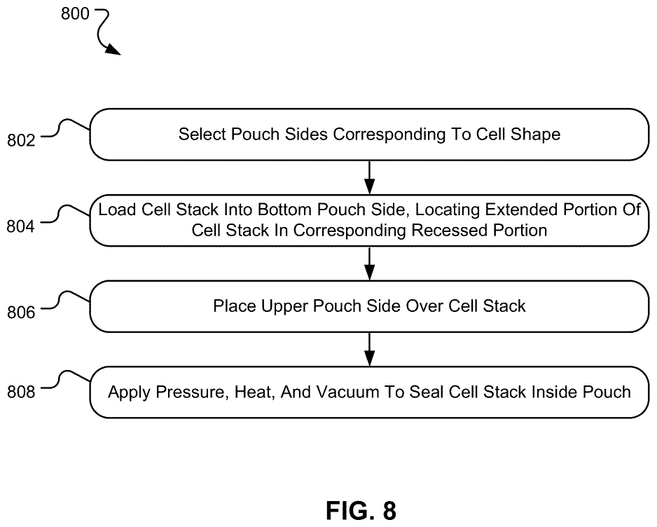

FIG. 8 is a representative flowchart of a method 800 for utilizing a contoured cell pouch, such as that described above, to seal a battery cell within a pouch. In operation 802, one or more pouch sides may be selected that correspond to the shape of the cell stack of the battery. For example, a bottom pouch side as illustrated above in FIG. 4 may be selected for a battery cell that includes extended portions on either side of the cell stack. The bottom pouch side in this example may include a contoured portion that corresponds or aligns with the extended portion of the cell stack near the conductive tabs of the cell stack. For other configurations, a suitable bottom pouch side may be selected. In operation 804, the cell stack for the battery may be loaded into the selected bottom pouch side. Loading the cell stack into the bottom pouch side may include aligning the extended portions of the cell at or near the conductive tabs into a corresponding contoured portion of the pouch recess so that the contoured portions can provide space within the recess for the extended portions.

In operation 806, an upper or top pouch side may be placed over the cell stack to encase the stack between the lower pouch side and the upper pouch side. As explained above, the upper pouch side may or may not include a contoured recess to accommodate at least a portion of the extended aspect of the cell stack. In one particular implementation, the upper pouch side may be a mirror image of the bottom pouch side to create, when the pouch sides are brough together, a space between and within the pouch sides for encasing the cell stack. Thus, at operation 808, pressure, heat, and/or a vacuuming procedure may be applied to portions of the pouch sides (such as the periphery portion of the pouch sides) to vacuum seal the cell stack between the pouch sides. As described above, the contoured portions of the pouch sides may protect one or more of the layers of the cell stack from bending stress on the layers during the sealing process of the pouch.

Although various representative embodiments of this invention have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention.

Various modifications and additions can be made to the exemplary embodiments discussed without departing from the scope of the present invention. For example, while the embodiments, also referred to as implementations or examples, described above refer to particular features, the scope of this invention also includes embodiments having different combinations of features and embodiments that do not include all of the described features. Accordingly, the scope of the present invention is intended to embrace all such alternatives, modifications, and variations together and in various possible combinations of various different features of different embodiments combined to form yet additional alternative embodiments, with all equivalents thereof.

While specific embodiments are discussed, it should be understood that this is done for illustration purposes only. A person skilled in the relevant art will recognize that other components and configurations may be used without parting from the spirit and scope of the disclosure. Thus, the above description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment”, or similarly “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Various features and advantages of the disclosure are set forth in the description above, and in part will be obvious from the description, or can be learned by practice of the herein disclosed principles. The features and advantages of the disclosure can be realized and obtained by means of the instruments and combinations particularly pointed out in the appended claims.

Features described above as well as those claimed below may be combined in various ways without departing from the scope hereof. The previous examples illustrate some possible, non-limiting combinations. It should thus be noted that the matter contained in the above description or shown in the accompanying drawings should be interpreted as illustrative and not in a limiting sense. The above-described embodiments should be considered as examples of the present disclosure, rather than as limiting its scope. In addition to the foregoing embodiments of inventions, review of the detailed description and accompanying drawings will show that there are other embodiments of such inventions. Accordingly, many combinations, permutations, variations, and modifications of the foregoing embodiments not set forth explicitly herein will nevertheless fall within the scope of this disclosure. The following claims are intended to cover generic and specific features described herein, as well as all statements of the scope of the present methods, systems, and devices, which, as a matter of language, might be said to fall there between.

What is claimed is:

1. A battery cell comprising:
a cell stack comprising a plurality of current collectors in an extended portion of the cell stack; and
a pouch comprising:
a recess formed around the cell stack; and
a conforming portion extending from the recess, the conforming portion receiving the extended portion of the cell stack adjacent to a conductive tab electrically coupled to the plurality of current collectors in the extended portion of the cell stack.

2. The battery cell of claim 1, wherein the conforming portion of the pouch comprises a first concave portion receiving the extended portion of the cell stack adjacent the recess, the first concave portion transitioning to a second curved convex portion.

3. The battery cell of claim 1, wherein the extended portion of the cell stack comprises a width less than a width of the cell stack, the width of the extended portion corresponding to a width of the conductive tab.

4. The battery cell of claim 1, wherein the pouch comprises an upper pouch side and a lower pouch side, each of the upper pouch side and the lower pouch side defining the recess formed around the cell stack and the conforming portion adjacent to the conductive tab coupled to the plurality of current collectors in the extended portion.

5. The battery cell of claim 4, wherein the conforming portion of the upper pouch side receives a top of the extended portion of the cell stack and the conforming portion of the lower pouch side receives a bottom of the extended portion of the cell stack.

6. The battery cell of claim 1, wherein the extended portion comprises a plurality of separator layers, the conforming portion reducing a bending stress on the separator layers during a sealing process of the pouch around the cell stack.

7. The battery cell of claim 1, wherein the extended portion of the cell stack is a first extended portion of the cell stack and further comprising a second extended portion of the cell stack, wherein the cell stack further comprises:
a plurality of anode layers electrically coupled to a first set of the plurality of current collectors; and
a plurality of cathode layers electrically coupled to a second set of the plurality of current collectors, the first set of the plurality of current collectors electrically coupled to an anode conductive tab at the first extended portion of the cell stack and the second set of the plurality of current collectors electrically coupled to a cathode conductive tab at the second extended portion of the cell stack;
wherein the pouch comprises the conforming portion receiving the first extended portion of the cell stack adjacent to the anode conductive tab and a second conforming portion receiving the second extended portion of the cell stack adjacent to the cathode conductive tab.

8. A method for a battery cell, the method comprising:
locating a cell stack of a battery in a first recess of a first pouch side, the cell stack comprising an extended portion comprising a conductive tab electrically coupled to a plurality of current collectors extending from the cell stack, wherein the first pouch side comprises a rigid and concave first conforming portion extending laterally from the first recess receiving a bottom of the extended portion of the cell stack including the conductive tab electrically coupled to the plurality of current collectors in the extended portion of the cell stack;
locating a second pouch side over the cell stack opposite the first pouch side, the second pouch side comprising a rigid and concave second conforming portion extending laterally from the second recess, the second conforming portion receiving a top of the extended portion of the cell stack, wherein the first conforming portion and a second conforming portion reduce a strain on the extended portion of the cell stack during the sealing; and
sealing the first pouch side to the second pouch side to encase the cell stack.

9. The method of claim 8, wherein sealing the first pouch side to the second pouch side comprises applying a pressure and a heating element to the second pouch side.

10. The method of claim 9, wherein sealing the first pouch side to the second pouch side further comprises vacuuming an interior of the first pouch side and the second pouch side.

11. The method of claim 8, wherein the first conforming portion comprises a first curved convex portion.

12. The method of claim 11, wherein the second conforming portion comprises a second curved convex portion.

13. The method of claim 8, wherein the cell stack comprises a plurality of anode layers and a plurality of cathode layers, the plurality of anode layers electrically coupled to a first current collector and the plurality of cathode layers electrically coupled to a second current collector different than the first current collector.

14. A conforming pouch for a battery cell comprising a first portion to receive a body of the battery cell and a second portion extending laterally from the first portion, the second portion receiving a conductive tab extending from the body of the battery cell, wherein the second portion comprises a rigid first concave portion disposed over the conductive tab to deter bending of the conductive tab during sealing of the battery cell within the conforming pouch.

15. The conforming pouch of claim 14, wherein second portion further comprises a rigid second curved convex portion adjacent to the first concave portion.

16. The conforming pouch of claim 14 further comprising a third portion extending laterally from the first portion opposite the second portion, the third portion receiving a second conductive tab extending laterally from the body of the battery cell, wherein the third portion comprises a rigid second concave portion disposed over the second conductive tab.

17. The conforming pouch of claim 14, wherein the first portion comprises a shape corresponding to a shape of the body of the battery cell.

18. The conforming pouch of claim 17, wherein the shape of the first portion comprises a rectangular shape.

19. The conforming pouch of claim 17, wherein the shape of the first portion comprises a non-rectangular shape.

20. The conforming pouch of claim 14, wherein the battery cell comprises: a plurality of anode layers electrically coupled to a first set of current collectors; and a plurality of cathode layers electrically coupled to a second set of current collectors, the first set of the current collectors electrically coupled to an anode conductive tab at the second portion of the battery cell.
